(19) United States
(12) Patent Application Publication
(10) Pub. No.: US 2004/0191045 A1
(43) Pub. Date: Sep. 30, 2004

(54) Hand-operated tool

(76) Inventors: Dieter Leuhmann, Wenzendorf (DE); Heinrich Peters, Wulmstorf (DE)

Correspondence Address: Stephan A Pendorf, Pendorf & Cutliff, 5111 Memorial Highway, Tampa, FL, 33634-7356, US

(21) Appl. No.: 10/485,379

(22) PCT Filed: Jul. 27, 2002
(86) PCT No.: PCT/EP02/08387

(30) Foreign Application Priority Data
Jul. 28, 2001 (DE) 201 12 495.5

(51) Int. Cl. B66C 23/00

(52) U.S. Cl. 414/743

(57) ABSTRACT

A hand-operated tool for the tipping of loads such as multi-wheeled axle vehicles, lawn mowers, tractor mowers, etc., comprising two separate parallel longitudinal spars (4), connected to each other at one end and together forming a bent end section (8), a socket sleeve (10), open at both ends, on the end section for insertion of a bar (30), whereby the axis (11) of the socket sleeve (10) runs at a given angle (β) to the spar plane between the longitudinal spars (4).

### BACKGROUND OF THE INVENTION

1. Field of the Invention

The invention concerns a hand-operated tool for tipping loads such as multi-wheeled axle vehicles, lawn mowers, tractor mowers, etc.

2. Description of the Related Art

Multi-wheel axle vehicles, which are propelled manually or by means of a drive, for example lawn mowers, tractor movers, etc., must often be cleaned or serviced from below, in order to guarantee a trouble free operation. For this purpose, this type of vehicle is either driven up a ramp or tipped on a side or lifted using a crane or, in certain cases, lifted using a car jack. Depending upon the weight of the vehicle this may be time consuming or cumbersome.

### SUMMARY OF THE INVENTION

It is thus the task of the invention to provide a hand operated tool which makes it possible to tip this kind of vehicle simply and with little body force and to stably hold it in the tilted condition.

This task is inventively solved using a tool of the type described in the introduction, having two spaced apart parallel longitudinal spars, which are joined at one end and which together form a bent end-section, and which have at their end-section a socket sleeve open at both ends for insertion of a bar, wherein the axis of the socket sleeve runs at a predetermined angle to the spar plane defined by the longitudinal spars.

The advantages of the invention lie in particular therein, that the tool has two straight, spaced apart longitudinal spars, which join at the angled end segment, wherein the straight segments of the longitudinal spars serve to take up the load, while the angled end-segment serves for supporting the load while in the tipped condition. On the end-segment there is provided a socket sleeve open on both ends into which a lever, for example a sufficiently long bar, can be introduced, in order to exercise manual torque, by means of which the tool together with the load can be tipped and be supported on the angled end-segment.

To receive the load the two longitudinal spars are pushed under the vehicle parallel to one wheel axle, so that the two longitudinal spars during tipping can engage the two wheels of one axle on both sides of the wheel axis and during tipping of the tool can come into contact against the two wheels and subsequently take along the vehicle during the tipping movement. The distance of the two longitudinal spars from each other is thus so dimensioned, that it is smaller than the wheel diameter, preferably also smaller than the rim diameter.

The axis of the insertion socket extends at a predetermined angle to the load receiving plane of the load bearing longitudinal spars, the insertion socket is preferably only at a small angle to the plane defined by the angled end-section. With this embodiment it is possible after tipping to push the bar used for tipping through the socket sleeve sufficiently such that the bar then lies with a predetermined longitudinal segment on the support surface under the vehicle to bring about a secure and reliable supporting of the tipped vehicle in the tipped position. The tipped vehicle is then prevented from tipping from its tilted orientation by the bar segment resting on the support surface, which extends parallel to the longitudinal axis of the vehicle.

Preferably a separate connecting piece is provided, which joins the two longitudinal spars with each other at their free ends, when the connecting piece is seated on the free ends of the longitudinal spars. The connecting piece moreover includes a spike or extension, which is oriented in the longitudinal direction of the longitudinal spars, and which can be set against the carried load in order to prevent the load from sliding off during the tipping process. The connecting piece includes two parallel spar sections, which can be seated upon the free ends of the longitudinal spars and thereby reinforce the total construction of the tool. Thereby the construction is so designed, that the spar segments can be seated on or introduced in the longitudinal spars to the extent until the spike comes into contact with the chassis. Alternatively or in addition the connecting piece can also be slid in its longitudinal direction and then be releasably fastened.

In the case that an improved stability is desired, flat cross bars can be provided between the longitudinal spars, which impart to the overall construction and improved stiffness or sturdiness. A cross bar is preferably provided there where the longitudinal spars transition from their load bearing section to the angled end-section, with the socket sleeve being attached at one end to the head of the angled end-section and at the other end to the cross bar.

The tool is preferably constructed of pipes which have a sufficient resistance to bending.

Preferred embodiments of the invention are set forth in the dependent claims.

### BRIEF DESCRIPTION OF THE DRAWINGS

In the following an illustrative embodiment of the invention will be described in greater detail on the basis of the figures. There is shown:

FIG. 1 a perspective view of the tool;

FIG. 2 a top view on the various parts of the tool;

FIG. 3 the base part of the tool as applied to a tipped vehicle; and

FIG. 4 the tool together with the vehicle in the tipped position.

### DETAILED DESCRIPTION OF THE INVENTION

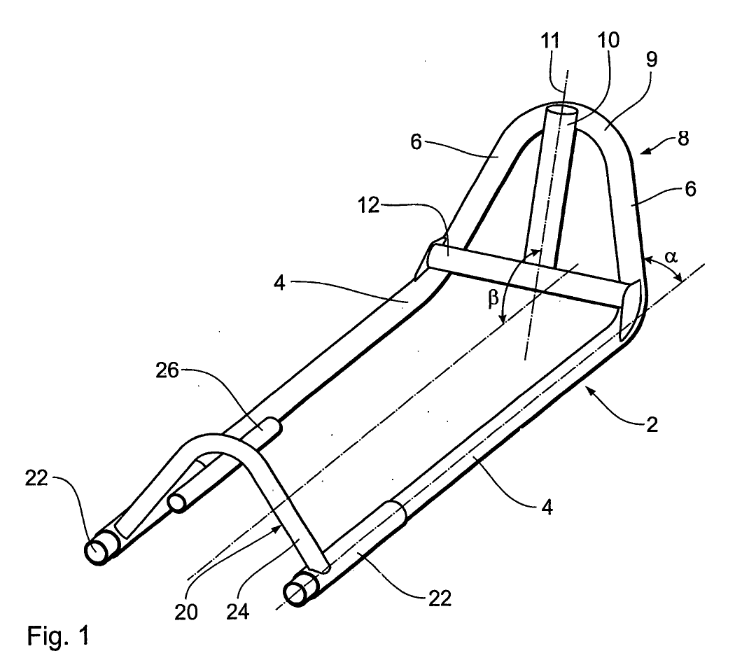

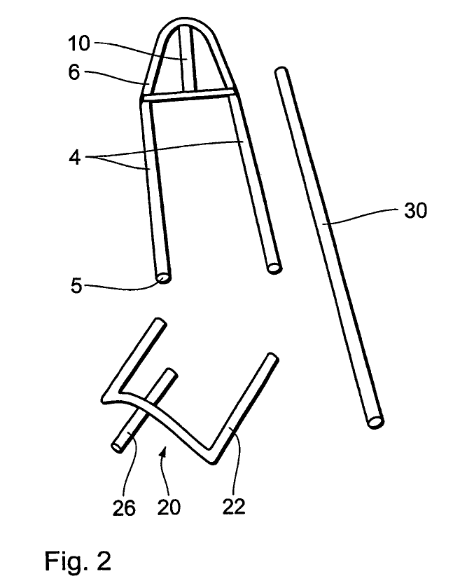

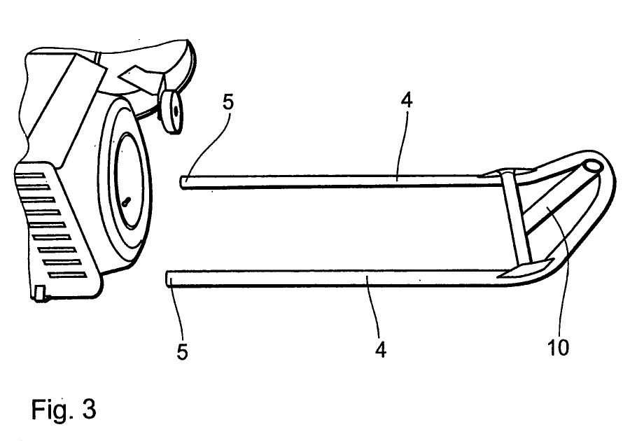

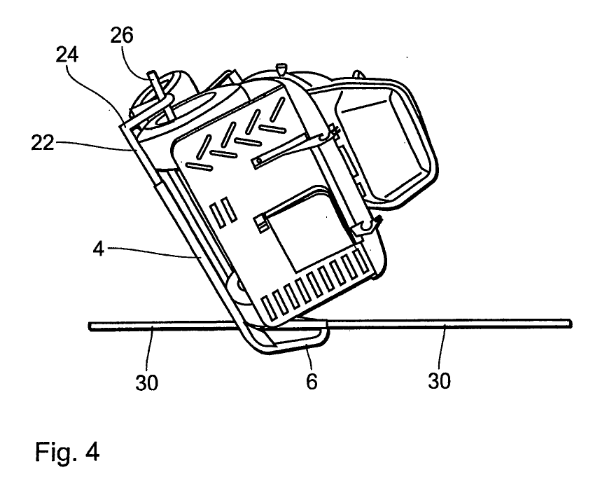

FIGS. 1 through 4 show the hand operated tool in an assembled condition (FIG. 1), in disassembled condition (FIG. 2) and during engagement with and tipping of a tractor mower (FIGS. 3, 4). The tool includes two parallel, straight longitudinal spars 4, which are angled at one end, forming an angled end-section 8 merging into each other and forming a head 9 at the end-section 8. At the location at which the longitudinal spars 4 bend, there is a cross-bar or strut or brace 12. The two longitudinal spars 4 form a load bearing section 2, which engages the load from below when taking up the load, see FIGS. 3 and 4.

At the angled end-section 8 there is secured a socket sleeve 10, open on both ends, which extends from the head 9 of the end-section 8 to the cross bar 12 and is attached both at the head 9 as well as at the cross bar 10.

The tool has a separate connecting piece 20, which has two parallel spars segments 22, which have the same orientation as the longitudinal spars 4 and can be connected by seating on the longitudinal spars 4. On the connecting piece 20 a spike 26 is provided parallel to the longitudinal spar segments 22, and the connecting piece 20 is adapted to being seated on the longitudinal spar 4 to the extent that the spike 26 comes into contact against the load which is to be taken up by the longitudinal spars 4 and tipped.

The angled end segment has an angle α to the plane of the longitudinal spar 4, which is 20° to 90° and thereby establishes the tip angle. The socket sleeve 10, which is connected in the shown embodiment to the head 9 of the end segment 8 and to the cross bar 12 has an axis 11, which runs either in the plane of the end segment 8 or is angled only slightly to this plane, describing an angle β of 90° to 170° to the plane of the longitudinal spars 20 and lies in a plane which is perpendicular to the plane defined by the longitudinal spars.

As an accessory to, or a component of, the tool, a bar 30 is provided, which, when the tool together with connecting piece is in position below the load, can engage in the socket sleeve and serves to apply the appropriate torque in order to tip the load (which in FIGS. 3 and 4 is a tractor mower). When the load is tipped, the end segment 8 of the tool is supported on the ground. In addition, the bar 30 is partially pushed through the socket sleeve 10 and forms along at least a partial segment thereof a support, which holds the load and the tool in the supported position transverse to the longitudinal axis of the vehicle.

1-11. (canceled)

12. A manual tool for sideways tipping of loads, comprising
two spaced apart parallel longitudinal spars (4), which define a spar plane, and which join at one end and together form an angled end section (8),
a socket sleeve (10), open on both ends, provided at the end section (8) and adapted for insertion of a bar (30),
wherein the socket sleeve (10) has an axis (11) oriented at a predetermined angle (β) to the plane defined by the longitudinal spars (4), and
wherein a connecting piece (20) is provided for connecting the two longitudinal spars (4) at their free ends (5), wherein the connecting piece includes a spike (26) at a predetermined spacing from the spar plane when the connecting piece is connected to the two longitudinal spars, and adapted to being placed in contact with the load.

13. A tool according to claim 12, wherein the axis (11) of the socket sleeve (10) extends essentially in a plane defined by the end segment (8).

14. A tool according to claim 12, further comprising a connecting piece (20) for connecting the two longitudinal spars (4) at their free ends (5), wherein the connecting piece (20) includes a spike (26) which, when the connecting piece is seated on the longitudinal spars, is at a predetermined distance from the plane defined by the longitudinal spars, and which is adapted to being placed against the load when the connecting piece is seated on the longitudinal spars.

15. A tool according to claim 14, wherein the connecting piece (20) includes two parallel spar segments (22), adapted to being seated upon the free ends (5) of the longitudinal spars (4).

16. A tool according to claim 14, wherein the connecting piece (20) can be connected to the longitudinal spars (4) to the extent that the spike (26) comes into contact with the load when the tool is supporting a load.

17. A tool according to claim 14, wherein the spike (26) is mounted to be slideable and fixable on the connecting piece (20).

18. A tool according to claim 12, wherein the longitudinal spars (4) are connected with each other via a flat cross bar.

19. A tool according to claim 12, wherein the angled end-segment of the longitudinal spars forms an angle (α) of 90° to 170° with the spar plane.

20. A tool according to claim 12, further comprising a bar (30), adapted to being introduced into the socket sleeve (10) for tipping of the load, and which after tipping of the load can be extended at least a predetermined length through the socket sleeve.

21. A tool according to claim 12, wherein the longitudinal spars (4), the spars (22) of the connecting piece (20), and the bar (30) are made of pipe.

22. A tool according to claim 12, further comprising a cross bar (12) comprised of pipe located where the longitudinal spars (4) transition to the angled end-segment (8), and wherein the socket sleeve (10) is secured to the head (9) of the end-segment and to the pipe-shaped cross strut (12).

23. A manual tool as in claim 12, wherein said load is a multi-wheeled vehicle.

24. A manual tool for sideways tipping of a multi-wheel vehicle, comprising
two parallel longitudinal spars (4), spaced apart at a distance less than the diameter of the wheels of the vehicle, adapted to being slid under the wheels of one axle of a vehicle, which longitudinal spars define a spar plane, and which join at one end and together form an angled end section (8),
a socket sleeve (10), open on both ends, provided at the end section (8) and adapted for insertion of a bar (30),
wherein the socket sleeve (10) has an axis (11) oriented at a predetermined angle (β) to the plane defined by the longitudinal spars (4), and
wherein a connecting piece (20) is provided for connecting the two longitudinal spars (4) at their free ends (5), wherein the connecting piece includes a spike (26) at a predetermined spacing from the spar plane when the connecting piece is connected to the two longitudinal spars, and adapted to being placed in contact with the vehicle being tipped by the manual tool.
